(19) United States
(12) Patent Application Publication
(10) Pub. No.: US 2005/0259755 A1
(43) Pub. Date: Nov. 24, 2005

(54) Fliterbank modulation system with pre-equalization

(75) Inventors: Stefano Tomasin, Venice (IT); Nevio Benvenuto, Mogliano Veneto (IT)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics, N.V., Eindhoven (NL)

(21) Appl. No.: 10/526,869

(22) PCT Filed: Aug. 4, 2003
(86) PCT No.: PCT/IB03/03415

§ 371 Date: Mar. 4, 2005

(30) Foreign Application Priority Data
Sep. 9, 2002 (EP) 02078702.4

(51) Int. Cl. H04B 14/04

(52) U.S. Cl. 375/242

(57) ABSTRACT

Filterbank-based modulation systems comprise sender-processors (20,30) with inverse-fast-fourier-transformating-modules (23,33) and filtering-modules (24,34) and comprise receiver-processors (40) with fast-fourier-transformating-modules (43). Interference caused by said filtering-modules (24,34) is reduced by, in said sender-processors (20,30), introducing coding-modules (22,32) with further-filtering-modules (26,36) in feedback loops, and by, in said receiver-processors (40), introducing decoding-modules (44). Splitting-modules (21,31,41) and combining-modules (25,35,45) allow the use of signal streams and parallel filterbanks. Coding-modules (22 resp. 32) comprise sub-coding-modules (22-1,22-2, . . . , 22-a or 32-1,32-2, . . . ,32-b), filtering-modules (24 resp. 34) comprise sub-filtering-modules (24-1,24-2, . . . ,24-a or 34-1,34-2, . . . ,34-b), further-filtering-modules (26 resp. 36) comprise sub-further-filtering-modules (26-1,26-2, . . . ,26-a or 36-1,36-2, . . . ,36-b), and decoding-modules (44) comprise sub-decoding-modules (44-1,44-2, . . . ,44-c), all per signal stream. The sub-further-filtering-modules either receive input signals from outputs of said inverse-fast-fourier-transformating-modules and supply output signals via fast-fourier-transformating-modules to inputs of said sub-coding-modules via adding/subtracting-modules for reducing interference per signal stream (or per subcarrier/subband), or receive input signals from outputs of said sub-coding-modules and supply output signal to inputs of said sub-coding-modules via adding/subtracting-modules for reducing interference per signal stream (or per subcarrier/subband) as well as between signal streams (or between subcarriers/subbands) and introducing so-called fractionally spaced filterbank-based modulation systems.

The invention relates to a filterbank-based modulation system comprising a sender with a sender-processor for processing data and sending processed data to a receiver and comprising said receiver with a receiver-processor for receiving and processing said processed data, which sender-processor comprises an inverse-fast-fourier-transformating-module and a filtering-module and which receiver-processor comprises a fast-fourier-transformating-module.

The invention also relates to a sender for use in a filterbank-based modulation system comprising said sender with a sender-processor for processing data and sending processed data to a receiver and comprising said receiver with a receiver-processor for receiving and processing said processed data, which sender-processor comprises an inverse-fast-fourier-transformating-module
and a filtering-module and which receiver-processor comprises a fast-fourier-transformating-module, and to a sender-processor for use in a sender for use in a filterbank-based modulation system comprising said sender with said sender-processor for processing data and sending processed data to a receiver and comprising said receiver with a receiver-processor for receiving and processing said processed data, which sender-processor comprises an inverse-fast-fourier-transformating-module and a filtering-module and which receiver-processor comprises a fast-fourier-transformating-module,
and to a processor program product to be run via a sender-processor for use in a sender for use in a filterbank-based modulation system comprising said sender with said sender-processor for processing data and sending processed data to a receiver and comprising said receiver with a receiver-processor for receiving and processing said processed data, which sender-processor comprises an inverse-fast-fourier-transformating-module and a filtering-module and which receiver-processor comprises a fast-fourier-transformating-module,
and to a receiver for use in a filterbank-based modulation system comprising a sender with a sender-processor for processing data and sending processed data to said receiver and comprising said receiver with a receiver-processor for receiving and processing said processed data, which sender-processor comprises an inverse-fast-fourier-transformating-module and a filtering-module and which receiver-processor comprises a fast-fourier-transformating-module,
and to a receiver-processor for use in a receiver for use in a filterbank-based modulation system comprising a sender with a sender-processor for processing data and sending processed data to said receiver and comprising said receiver with a receiver-processor for receiving and processing said processed data, which sender-processor comprises an inverse-fast-fourier-transformating-module and a filtering-module and which receiver-processor comprises a fast-fourier-transformating-module,
and to a processor program product to be run via a receiver-processor for use in a receiver for use in a filterbank-based modulation system comprising a sender with a sender-processor for processing data and sending processed data to said receiver and comprising said receiver with a receiver-processor for receiving and processing said processed data, which sender-processor comprises an inverse-fast-fourier-transformating-module and a filtering-module and which receiver-processor comprises a fast-fourier-transformating-module,
and to a method for filterbank-based modulation via a sender with a sender-processor for processing data and sending processed data to a receiver and via said receiver with a receiver-processor for receiving and processing said processed data, which method comprises the steps of performing inverse fast fourier transformations and of filtering signals in said sender and of performing fast fourier transformations in said receiver.

Such a filterbank-based modulation system for example forms part of a Digital Subscriber Line modem or DSL modem or of a Code Division Multiple Access system or CDMA system or of another wireless or wired system etc., with said sender and said receiver then each forming part of a transceiver.

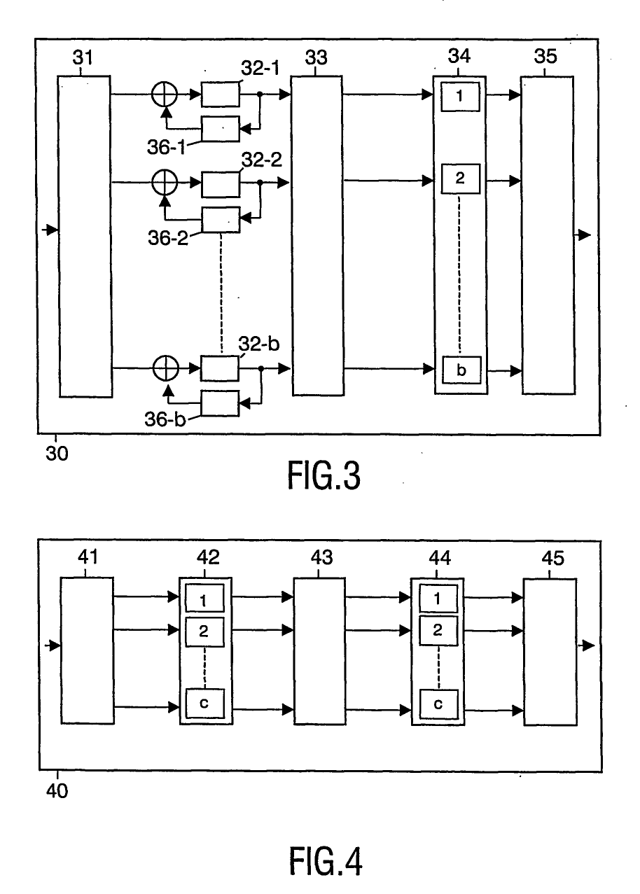

A prior art modulation system is known from the IEEE article “Combined OFDM-CDMA configuration for multimedia wireless applications” by Saverio Cacopadi, Fabrizio Frescura and Gianluca di Perugia, 1996. This article discloses in its FIG. 3 a modulation system comprising a sender (transmitter in FIG. 3a) for processing data and sending processed data to a receiver (receiver in FIG. 3b) and comprising said receiver for receiving and processing said processed data, which sender comprises an inverse-fast-fourier-transformating-module (IEFT) and which receiver comprises a fast-fourier-transformating-module (FFT). For making such a modulation system filterbank-based, a filtering-module is introduced in said sender after said IFFT-module. Sender modules generally form part of (are implemented by) a sender-processor and receiver modules generally form part of (are implemented by) a receiver-processor.

The known filterbank-based modulation system is disadvantageous, inter alia, due to said filtering-module introducing interference.

It is an object of the invention, inter alia, of providing a filterbank-based modulation system in which interference caused by said filtering-module is reduced.

To this end, in the filterbank-based modulation system according to the invention said sender-processor comprises a coding-module with a further-filtering-module in at least one feedback loop, which coding-module is situated before said inverse-fast-fourier-transformating-module, with said receiver-processor comprising a decoding-module situated after said fast-fourier-transformating-module.

By introducing in said sender said coding-module with said further-filtering-module in the at least one feedback loop, and then introducing the corresponding decoding-module in said receiver, a kind of pre-equalisation is introduced into said sender, which reduces interference caused by said filtering-module.

The invention is based upon an insight, inter alia, that the transmission channel between sender and receiver will disturb any equalisation process in the receiver, and is based upon a basic idea, inter alia, that at least a part of this equalisation process in the receiver can be shifted from receiver to sender.

The invention solves the problem, inter alia, of providing an improved filterbank-based modulation system, and is advantageous, inter alia, in that the signal-to-noise-ratio of the filterbank-based modulation system is increased and that the bit-error-rate of the filterbank-based modulation system is reduced.

It should be observed that, where said prior art article is particularly related to Orthogonal Frequency Division Multiplexing or OFDM, the filterbank-based modulation system according to the invention is generally related to Filtered Multitone Modulation, without excluding said OFDM.

A first embodiment of the filterbank-based modulation system according to the invention is advantageous in that said sender-processor comprises a splitting-module for splitting said data into signal streams and a combining-module for combining signal streams into said processed data, with said inverse-fast-fourier-transformating-module and said filtering-module and said coding-module with said further-filtering-module in at least one feedback loop being situated between said splitting-module and said combining-module, and with said receiver-processor comprising a splitting-module for splitting said processed data into signal streams and a combining-module for combining signal streams into further processed data, with said fast-fourier-transformating-module and said decoding-module being situated between said splitting-module and said combining-module.

Said splitting-modules and said combining-modules advantageously introduce said signal streams in combination with filterbanks (with each signal stream corresponding with a subcarrier/subband).

A second embodiment of the filterbank-based modulation system according to the invention is advantageous in that said coding-module comprises a sub-coding-module per signal stream, with said filtering-module comprising a sub-filtering-module per signal stream, with said further-filtering-module comprising a sub-further-filtering-module per signal stream, and with said decoding-module comprising a sub-decoding-module per signal stream.

Said sub-modules advantageously make the filterbank-based modulation system a low complex and easy-to-implement system.

A third embodiment of the filterbank-based modulation system according to the invention is advantageous in that said sub-further-filtering-modules receive input signals from outputs of said inverse-fast-fourier-transformating-module and supply output signals via a fast-fourier-transformating-module to inputs of said sub-coding-modules via adding/subtracting-modules.

This third embodiment advantageously reduces interference per signal stream (or per subcarrier/subband).

A fourth embodiment of the filterbank-based modulation system according to the invention is advantageous in that said sub-further-filtering-modules receive input signals from outputs of said sub-coding-modules and supply output signal to inputs of said sub-coding-modules via adding/subtracting-modules.

This fifth embodiment advantageously reduces interference per signal stream (or per subcarrier/subband) as well as between signal streams (or between subcarriers/subbands) and introduces a so-called fractionally spaced filterbank-based modulation system.

It should be observed that the term “situated” does not necessarily define a “location” limitedly but merely defines an order in which the modules take action. Further, the term “signal streams” does not necessarily define “parallel signals” or “serial signals” limitedly but merely defines that the data is splitted into several signals which are processed partly individually and partly in combination and which are then combined into processed data.

Embodiments of the sender according to the invention, of the sender-processor according to the invention, of the processor program product according to the invention to be run via the sender-processor, of the receiver according to the invention, of the receiver-processor according to the invention, of the processor program product according to the invention to be run via the receiver-processor and of the method according to the invention correspond with the embodiments of the filterbank-based modulation system according to the invention.

These and other aspects of the invention will be apparent from and elucidated with reference to the embodiments(s) described hereinafter.

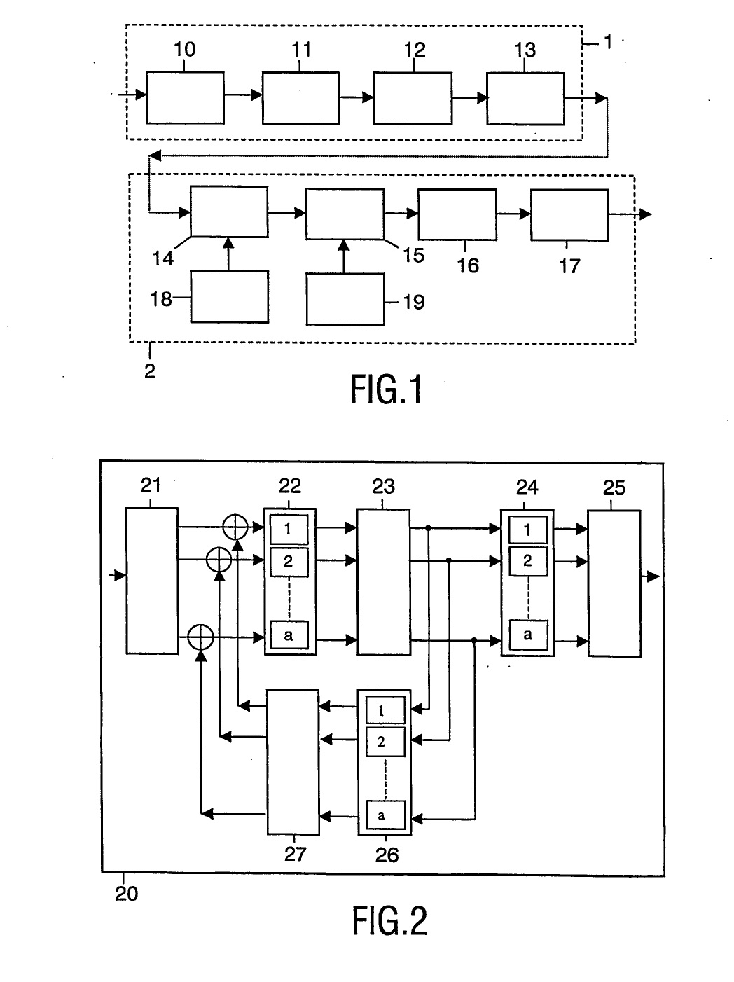

FIG. 1 illustrates in block diagram form a filterbank-based modulation system according to the invention,

FIG. 2 illustrates in block diagram form a sender-processor according to the invention as defined by the third embodiment,

FIG. 3 illustrates in block diagram form a sender-processor according to the invention as defined by the fourth embodiment, and

FIG. 4 illustrates in block diagram form a receiver-processor according to the invention.

The filterbank-based modulation system shown in FIG. 1 comprises a sender 1 and a receiver 2. Sender 1 comprises from input to output an encoder 10, a mapper 11, a modulator 12 and a frontend 13. Receiver 2 comprises from input to output a frontend 14, an equalizer 15, a demapper 16 and a decoder 17, with frontend 14 being further coupled to a synchroniser 18 and with equalizer 15 being further coupled to a estimater 19.

Modulator 12 for example comprises a sender-processor 20 as shown in FIG. 2. This sender-processor 20 comprises a splitting-module 21 having an input for receiving data from mapper 11 and having 1,2, . . . , a outputs each coupled via an adding/subtracting-module to inputs of sub-coding-modules 22-1,22-2, . . . ,22-a. Outputs of these sub-coding-modules 22-1,22-2, . . . ,22-a are coupled to inputs of an inverse-fast-fourier-transformating-module 23, of which outputs are coupled to inputs of sub-filtering-modules 24-1,24-2, . . . ,24-a and to inputs of sub-further-filtering-modules 26-1,26-2, . . . ,26-a. Outputs of sub-filtering-modules 24-1,24-2, . . . ,24-a are coupled to inputs of a combining module 25 having an output for generating processed data to be supplied to frontend 13. Outputs of sub-further-filtering-modules 26-1,26-2, . . . ,26-a are coupled to inputs of a fast-fourier-transformating-module 27, of which outputs are coupled to said adding/subtracting-modules (whether these adding/subtracting-modules add or subtract depends upon the output signals of said fast-fourier-transformating-module 27 being not-inverted or inverted).

Sub-coding-modules 22-1,22-2, . . . ,22-a and sub-further-filtering-modules 26-1,26-2, . . . ,26-a together form a coding-module 22 with a further-filtering-module 26 in at least one feedback loop. Coding-module 22, filtering-module 24 and further-filtering-module 26 respectively comprise a sub-coding-module 22-1,22-2, . . . ,22-a, a sub-filtering-module 24-1,24-2, . . . ,24-a and a sub-further-filtering-module 26-1,26-2, . . . ,26-a respectively per signal stream, with splitting-module 21 splitting said data into signal streams and with said combining-module 25 combining said signal streams into said processed data.

Alternatively, modulator 12 for example comprises a sender-processor 30 as shown in FIG. 3. This sender-processor 30 comprises a splitting-module 31 having an input for receiving data from mapper 11 and having 1,2, . . . ,b outputs each coupled via an adding/subtracting-module to inputs of sub-coding-modules 32-1,32-2, . . . ,32-b. Outputs of these sub-coding-modules 32-1,32-2, . . . ,32-b are coupled to inputs of sub-further-filtering-modules 36-1,36-2, . . . ,36-b and to inputs of an inverse-fast-fourier-transformating-module 33, of which outputs are coupled to inputs of sub-filtering-modules 34-1,34-2, . . . ,34-b. Outputs of sub-filtering-modules 34-1,34-2, . . . ,34-b are coupled to inputs of a combining module 35 having an output for generating processed data to be supplied to frontend 13. Outputs of sub-further-filtering-modules 36-1,36-2, . . . ,36-b are coupled to said adding/subtracting-modules (whether these adding/subtracting-modules add or subtract depends upon the output signals of said sub-further-filtering-modules 36-1,36-2, . . . ,36-b being not-inverted or inverted).

Sub-coding-modules 32-1,32-2, . . . ,32-b and sub-further-filtering-modules 36-1,36-2, . . . ,36-b together form a coding-module 32 with a further-filtering-module 36 in at least one feedback loop (in this case b feedback loops). Coding-module 32, filtering-module 34 and further-filtering-module 36 respectively comprise a sub-coding-module 32-1,32-2, . . . ,32-b, a sub-filtering-module 34-1,342, . . . ,34-b and a sub-further-filtering-module 36-1,36-2 . . . ,36-b respectively per signal stream, with splitting-module 31 splitting said data into signal streams and with said combining-module 35 combining said signal streams into said processed data.

Equalizer 15 for example comprises a receiver-processor 40 as shown in FIG. 4. This receiver-processor 40 comprises a splitting-module 41 having an input for receiving processed data from frontend 14 and having 1,2, . . . ,c outputs each coupled to inputs of sub-filtering-modules 42-1,42-1, . . . ,42-c. Outputs of these sub-filtering-modules 42-1,42-2, . . . ,42-c are coupled to inputs of a fast-fourier-transformating-module 43, of which outputs are coupled to inputs of sub-decoding-modules 44-1,44-2, . . . ,44-c. Outputs of sub-decoding-modules 44-1,44-2, . . . ,44-c are coupled to inputs of a combining module 45 having an output for generating further processed data to be supplied to demapper 16.

Filtering-module 42 and decoding-module 44 respectively comprise a sub-filtering-module 42-1,42-2, . . . ,42-c and a sub-decoding-module 44-1,44-2, . . . ,44-c respectively per signal stream, with splitting-module 41 splitting said processed data into signal streams and with said combining-module 45 combining said signal streams into said further processed data.

In the filterbank-based modulation system according to the invention, filtering-modules 24,34 are filterbanks, in which, generally, the filtering-modules 24-1,24-2, . . . ,24-a,34-1,34-2, . . . ,34-b are interpolating filters which are for example equally-spaced frequency-shifted versions of a prototype filter defined by h^{(m)}=he^{j2πm/y} with y being equal to a (filtering-module 24) or b (filtering-module 34). These filterbanks are based upon multicarrier transmission. The spectrum is divided into subbands and signal streams are transmitted on each subband. The purpose of the interpolating filters is the allocation of each signal stream into a specific subband, thus selecting the portion of the spectrum which is used for that particular signal stream. Since each subband has a smaller bandwidth than the overall available bandwidth, the data of high-rate symbols (rate 1/T) at the input of the modulator is divided into a set of y parallel low-rate signal streams (rate 1/yT), and each signal stream is then modulated by an interpolating filter h^{(m)}. After the ideal interpolation by y the spectrum of signals exhibits y replicas of the original signal. The filter h^{(m)} selects only one of the replicas.

Splitting-modules 21,31,42 receive input sequences of samples s(0), s(1), s(2) . . . , s(y−1), s(y), s(y+1), s(y+2). . . . s(2y−1), s(2y), s(2y+1). . . . and generate sequences of blocks [s(0), s(1) . . . s(y−1)]; [s(y), s(y+1) . . . s(2y−1)]; [s(2y), s(2y+1) . . . s(3y−1)] . . . . Each block contains y samples of the input sequence. Combining-modules 25,35,45 receive input sequences of blocks [s(0), s(1) . . . s(y−1)]; [s(y), s(y+1) . . . s(2y−1)]; [s(2y), s(2y+1) . . . s(3y−1)] . . . . and generate sequences of samples s(0), s(1), s(2) . . . s(y−1), s(y), s(y+1), s(y+2). . . . s(2y−1), s(2y), s(2y+1) . . . .

Coding-modules 22,32 perform a modulo division by N and generate complex numbers (r₁+j r₂), in case of the symbols being complex numbers (p+jq) with p and q=−N, −N+1, . . . 0, 1, . . . N, and with the real and imaginary part of the input symbol z being written as zᵣₑₐₗ=k₁·2N+r₁ and z_{imaginary}=k₂·2N+r₂, respectively, where k₁ and k₂ are integers and −N≦r₁, r₂<N (half open interval).

Further-filtering-module 26 in the sender-processor 20 and filtering-module 42 in the receiver-processor 40 (when in combination with sender-processor 20) are for example designed in accordance with the Thomlinson-Harashima design.

Further-filtering-module 36 in the sender-processor 30 is for example designed in accordance with the following. Assuming a flat transmission channel per subchannel, the overall system is a cascade of an IFFT, a filterbank with an impulse response qk^{(m)}=(h^{(m)}*g^{(m)})ₖ with k=1,2 . . . N_{q}−1, and a FFT. To derive a relation between d^{˜}ₘ(i) and dₘ(k), an average subchannel total impulse response is defined as qₖ=1/M·Σ(from m=0 to m=M−1) of qₖ^{(m)}=1/M·Σ(from m=0 to m=M−1 of) Σ (from n=0 to n=N_{g}−1 of) gₙ^{(m)}hₖ₋ₙ^{(m)} with k=0,1,2 . . . N_{q}−1 and N_{q}=N_{g}+Nₕ−1. Assuming the filters yield a delay Δ, bₖ=−q_{k+Δ} with k=0,1 . . . . N_{b}−1 and N_{b}=N_{q}−Δ. This bₖ defines further-filtering-module 36.

Filtering-module 42 in the receiver-processor 40 (when in combination with sender-processor 30) is then for example designed by solving the following. Γh_{Δ-n}^{(m)*}+gₙ^{(m)}+ΓΣ (from r=0 to r=M−1 of) {gᵣ^{(m)}·Σ (from k=0 to k=N_{q}−1 of) hₖ₋ᵣ^{(m)}hₖ₋ₙ^{(m)*}−1/M·Σ (from p=0 to p=M−1 of) gₙ^{(p)}[Σ (from k=Δ to k=N_{q}−1 of) hₖ₋ᵣ^{(p)}hₖ₋ₙ^{(m)*}+h_{Δ-r}^{(p)}h_{Δ-n}^{(m)*}]}=0, with Γ being the average signal-to-noise-ratio, and a* indicating the complex conjugate of a. The g^{(m)} defines filtering-module 42.

Decoding-module 44 (when in combination with sender-processor 20 or 30) is for example designed in the form of an equalizing decoder or a Viterbi decoder.

Sender-processors 20 and 30 and receiver processor 40 are for example Digital Signal Processors. However, other kinds of processors are not to be excluded, like for example processing circuits comprising gate circuits, latch circuits, multiplexers, demultiplexers, clock generators for clocking at least one of said circuits etc.

Each module and/or each part of the system can be 100% hardware, 100% software or a mixture of both. The fact that one or more inputs and/or one or more outputs of a module are coupled to one or more inputs and/or one or more outputs of another module and/or to another part of the system may imply a 100% software coupling, a 100% hardware coupling or a mixture of both.

In view of the foregoing it will be evident to a person skilled in the art that various modifications may be made within the spirit and the scope of the invention as hereinafter defined by the appended claims and that the invention is thus not limited to the examples provided. The word “comprising” does not exclude the presence of other elements or steps than those listed in a claim, “a” or “an” does not exclude a plurality, and a single processor or other unit may fulfill the functions of several means recited in the claims.

1. Filterbank-based modulation system comprising a sender with a sender-processor for processing data and sending processed data to a receiver and comprising said receiver with a receiver-processor for receiving and processing said processed data, which sender-processor comprises an inverse-fast-fourier-transformating-module and a filtering-module and which receiver-processor comprises a fast-fourier-transformating-module, said sender-processor comprising a coding-module with a further-filtering-module in at least one feedback loop, which coding-module is situated before said inverse-fast-fourier-transformating-module, with said receiver-processor comprising a decoding-module situated after said fast-fourier-transformating-module.

2. Filterbank-based modulation system according to claim 1, wherein said sender-processor comprises a splitting-module for splitting said data into signal streams and a combining-module for combining signal streams into said processed data, with said inverse-fast-fourier-transformating-module and said filtering-module and said coding-module with said further-filtering-module in at least one feedback loop being situated between said splitting-module and said combining-module, and with said receiver-processor comprising a splitting-module for splitting said processed data into signal streams and a combining-module for combining signal streams into further processed data, with said fast-fourier-transformating-module and said decoding-module being situated between said splitting-module and said combining-module.

3. Filterbank-based modulation system according to claim 2, wherein said coding-module comprises a sub-coding-module per signal stream, with said filtering-module comprising a sub-filtering-module per signal stream, with said further-filtering-module comprising a sub-further-filtering-module per signal stream, and with said decoding-module comprising a sub-decoding-module per signal stream.

4. Filterbank-based modulation system according to claim 3, wherein said sub-further-filtering-modules receive input signals from outputs of said inverse-fast-fourier-transformating-module and supply output signals via a fast-fourier-transformating-module to inputs of said sub-coding-modules via adding/subtracting-modules.

5. Filterbank-based modulation system according to claim 3, said sub-further-filtering-modules receive input signals from outputs of said sub-coding-modules and supply output signal to inputs of said sub-coding-modules via adding/subtracting-modules.

6. Sender for use in a filterbank-based modulation system comprising said sender with a sender-processor for processing data and sending processed data to a receiver and comprising said receiver with a receiver-processor for receiving and processing said processed data, which sender-processor comprises an inverse-fast-fourier-transformating-module and a filtering-module and which receiver-processor comprises a fast-fourier-transformating-module, said sender-processor comprising a coding-module with a further-filtering-module in at least one feedback loop, which coding-module is situated before said inverse-fast-fourier-transformating-module.

7. Sender-processor for use in a sender for use in a filterbank-based modulation system comprising said sender with said sender-processor for processing data and sending processed data to a receiver and comprising said receiver with a receiver-processor for receiving and processing said processed data, which sender-processor comprises an inverse-fast-fourier-transformating-module and a filtering-module and which receiver-processor comprises a fast-fourier-transformating-module, said sender-processor comprising a coding-module with a further-filtering-module in at least one feedback loop, which coding-module is situated before said inverse-fast-fourier-transformating-module.

8. Processor program product to be run via a sender-processor for use in a sender for use in a filterbank-based modulation system comprising said sender with said sender-processor for processing data and sending processed data to a receiver and comprising said receiver with a receiver-processor for receiving and processing said processed data, which sender-processor comprises an inverse-fast-fourier-transformating-module and a filtering-module and which receiver-processor comprises a fast-fourier-transformating-module, said sender-processor comprising a coding-module with a further-filtering-module in at least one feedback loop, which coding-module is situated before said inverse-fast-fourier-transformating-module.

9. Receiver for use in a filterbank-based modulation system comprising a sender with a sender-processor for processing data and sending processed data to said receiver and comprising said receiver with a receiver-processor for receiving and processing said processed data, which sender-processor comprises an inverse-fast-fourier-transformating-module and a filtering-module and which receiver-processor comprises a fast-fourier-transformating-module, said receiver-processor comprising a decoding-module situated after said fast-fourier-transformating-module.

10. Receiver-processor for use in a receiver for use in a filterbank-based modulation system comprising a sender with a sender-processor for processing data and sending processed data to said receiver and comprising said receiver with a receiver-processor for receiving and processing said processed data, which sender-processor comprises an inverse-fast-fourier-transformating-module and a filtering-module and which receiver-processor comprises a fast-fourier-transformating-module, said receiver-processor comprising a decoding-module situated after said fast-fourier-transformating-module.

11. Processor program product to be run via a receiver-processor for use in a receiver for use in a filterbank-based modulation system comprising a sender with a sender-processor for processing data and sending processed data to said receiver and comprising said receiver with a receiver-processor for receiving and processing said processed data, which sender-processor comprises an inverse-fast-fourier-transformating-module and a filtering-module and which receiver-processor comprises a fast-fourier-transformating-module, said receiver-processor comprising a decoding-module situated after said fast-fourier-transformating-module.

12. Method for filterbank-based modulation via a sender with a sender-processor for processing data and sending processed data to a receiver and via said receiver with a receiver-processor for receiving and processing said processed data, which method comprises the steps of performing inverse fast fourier transformations and of filtering signals in said sender and of performing fast fourier transformations in said receiver, said method comprising the steps of coding signals and of further filtering signals in at least one feedback loop in said sender, which coding is performed before said inverse fast fourier transformations, and of decoding signals in said receiver, which decoding is performed after said fast fourier transformation.
